(19) United States
(12) Patent Application Publication
(10) Pub. No.: US 2002/0117977 A1
(43) Pub. Date: Aug. 29, 2002

(54) Discharge device and plasma gas generating apparatus employing same

(76) Inventor: Sung Don Park, Ilsan-gu (KR)

Correspondence Address: LOWE HAUPTMAN GOPSTEIN, GILMAN & BERNER, LLP, SUITE 310, 1700 DIAGONAL ROAD, ALEXANDRIA, VA, 22314, US

(21) Appl. No.: 09/794,325

(22) Filed: Feb. 28, 2001

(51) Int. Cl. H05B 31/26; H05B 37/02

(52) U.S. Cl. 315/291

(57) ABSTRACT

A discharge device and an apparatus for generating plasma gas employing the same are disclosed. The discharge device enables a discharge phenomenon to occur between a dish-shaped electrode arranged inside an electrical bulb and a plate electrode located outside of the electrical bulb. And the apparatus for generating the plasma gas utilizes the discharge device to efficiently produce the plasma gas. The discharge device for generating discharge between electrodes by applying a predetermined high voltage therebetween, comprises, at least one bulb containing at least one dish-shaped electrode therein; and at least one plate electrode having at least one hole through which the bulb is inserted, and located coplanar with the dish-shaped electrode. In the case that a plurality of dish-shaped electrodes and a plurality of plate electrodes are provided, a sufficient amount of plasma gas which are used in the wastewater treatment system.

### BACKGROUND OF THE INVENTION

1. Field of the Invention

The present invention relates to a discharge device and a plasma gas generating apparatus that employs the discharge device. More particularly, the invention is directed to a discharge device which enables a discharge phenomenon to occur between a dish-shaped electrode arranged inside an electrical bulb and a plate electrode located outside of the electrical bulb, thereby efficiently producing the plasma gas.

2. Description of the Related Art

Environmental problems such as contamination of water and contamination of the atmosphere are becoming of greater concern. In order to solve such environmental problems, developments of techniques for removing contaminants are also being advanced. For example, a method has been proposed in which active substances such as rays of light, radicals, ions or ozone are produced and forced to come into contract with contaminants, thereby decomposing those contaminants.

In order to produce the active substances to be used in the above mentioned method, a discharge method has mainly been used in which high voltage is applied to an ultraviolet lamp or a metal discharge prove to generate a discharge action. However, the apparatus used to conduct this method is very complex and expensive while requiring high operating costs. Furthermore, this apparatus is likely to vary in performance because it is sensitive to surrounding conditions such as humidity, temperature and cleanliness. In particular, there is a problem in that the apparatus exhibits an abrupt degradation in the ability to generate the plasma gas after a lengthened use due to an attachment of contaminants to the discharge probe.

In order to solve such problems involved in the above conventional technique, a highly active radiation ray and ion producing apparatus has been proposed by the inventor of the present application. This apparatus is disclosed in International Patent Laid-open Publication No. WO99/39808 corresponding to International Patent Application No.PCT/FR98/00220 filed in the name of the inventor on Jul. 21, 1998.

The highly active radiation ray and ion producing apparatus includes a high voltage generator, an electrostatic induction unit for supplying high voltage generated from the high voltage generator to a plurality of electric bulbs in a distributed manner, and a conductive discharge unit arranged adjacent to the plurality of the electrical bulbs.

For the electric bulbs of this apparatus, typical bulbs or filament-broken waste bulbs may be used. According to this apparatus, an electric discharge phenomenon occurs between the filament of each electrical bulbs and an external discharge member, so that the active substances are produced.

The inventor has made an effort to further improve the above mentioned invention. By virtue of such an effort, a discharge device having a greatly improved discharge efficiency has been developed along with an apparatus generating plasma gas using the discharge device.

The plasma gas is defined as a gas component of the active substances which are generated at a discharge state. In order to rapidly and intensively decompose a variety of contaminants for removal of those contaminants, a large amount of plasma gas can be inexpensively obtained.

### SUMMARY OF THE INVENTION

Accordingly, one object of the present invention is to provide a discharge device which efficiently generates plasma gas used in a wastewater treatment system.

Another object of the present invention is to provide a plasma gas generation apparatus using the discharge device.

Still another object of the present invention is to provide an electrical bulb utilized at the discharge device which efficiently generates plasma gas.

In accordance with the present invention, there is provided a discharge device for generating discharge between electrodes by applying a predetermined high voltage therebetween, which comprises: at least one bulb containing at least one dish-shaped electrode therein; and at least one plate electrode having at least one hole through which the bulb is inserted, and located coplanar with the dish-shaped electrode.

In accordance with the present invention, there is provided an apparatus for producing plasma gas by using a discharge phenomenon, which comprises: means for generating a predetermined high voltage at which the discharge phenomenon occurs; a discharge device for generating the discharge phenomenon, the discharge device having at least one bulb containing at least one dish-shaped electrode therein, and at least one plate electrode having at least one hole through which the bulb is inserted, and located coplanar with the dish-shaped electrode; and means for distributedly supplying the high voltage to each of the bulbs in case that the discharge device includes at least two bulbs.

In accordance with the present invention, there is provided a bulb used in a discharge device for generating discharge between electrodes by applying a predetermined high voltage therebetween, which comprises: fixing means fastened to a socket; means for defining an inner space in which vacuum is introduced or which is filled with inactive gas, the inner space airtightly maintained; conductive means for transmitting the voltage supplied from the outside; and at least one dish-shaped electrode connected to the conductive means for enabling discharge to occur between the dish-shaped electrode and another electrode which is located outside bulb, thereby generating the discharge phenomenon.

### BRIEF DESCRIPTION OF THE DRAWINGS

The above objects, and other features and advantages of the present invention will become more apparent after a reading of the following detailed description when taken in conjunction with the drawings, in which:

FIG. 1 is a schematic block diagram of a wastewater process system using a plasma gas generation apparatus in accordance with the present invention;

FIG. 2 shows a schematic block diagram of the plasma gas generation apparatus in accordance with the present invention;

FIG. 3 describes a perspective view of a basic type of discharge device used in the plasma gas generation apparatus in accordance with the present invention;

FIG. 4 illustrates a perspective view of a number of discharge devices used in the plasma gas generation apparatus in accordance with the present invention; and

FIG. 5 is a systematic view illustrating a set of discharge devices each of which has three number of dish-shaped electrodes and plate electrodes in accordance with another embodiment of the present invention.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

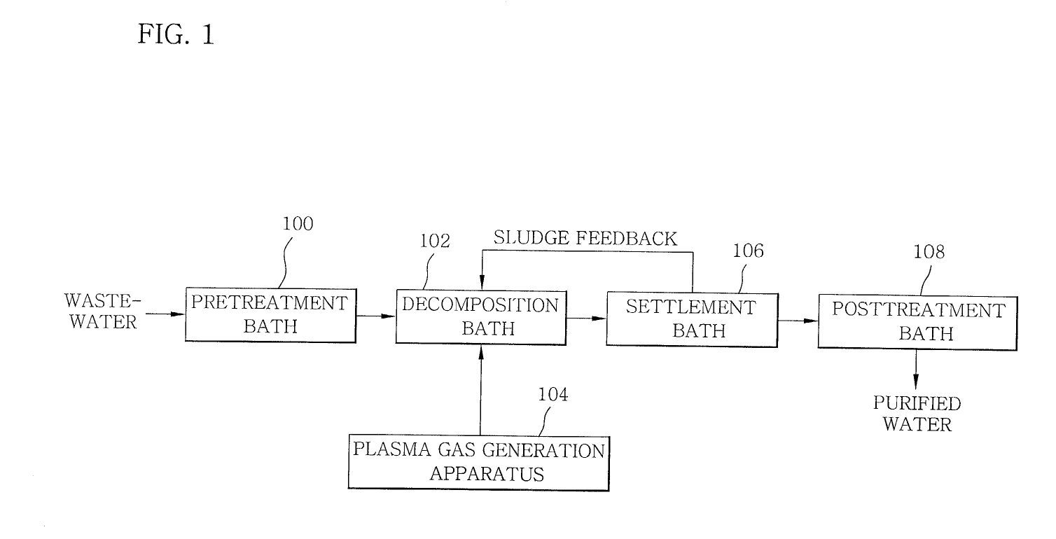

FIG. 1 is a schematic block diagram of a wastewater treatment system using a plasma gas generation apparatus in accordance with the present invention.

As shown in FIG. 1, wastewater is provided to a pretreatment bath 100 wherein screening, a comminuting, and a grease and scum removal processes may be performed according to the wastewater.

Thereafter, the wastewater from the pretreatment bath 100 is provided to a decomposition bath 102 wherein a decomposition is processed by using plasma gas provided from a plasma gas generation apparatus 104 which is detailed described below.

The output from the decomposition bath 102 is provided to a settlement bath 106 wherein sludge is settled. The settled sludge is feedback to the decomposition bath 102.

Finally, the output from the settlement bath 106 is provided to a posttreatment bath 108 wherein suspended and dissolved organic solids is removed by means of posttreatment process including filtration, removal of pathogens and chloroforms by oxidation, chlorination or heating, precipitation of mineral, adsorption or other methods.

In above described wastewater treatment system, in order to continuously remove great amount of contaminants at the decomposition bath 102, the plasma gas generation apparatus 104 have to effectively produce a large amount of the plasma gas.

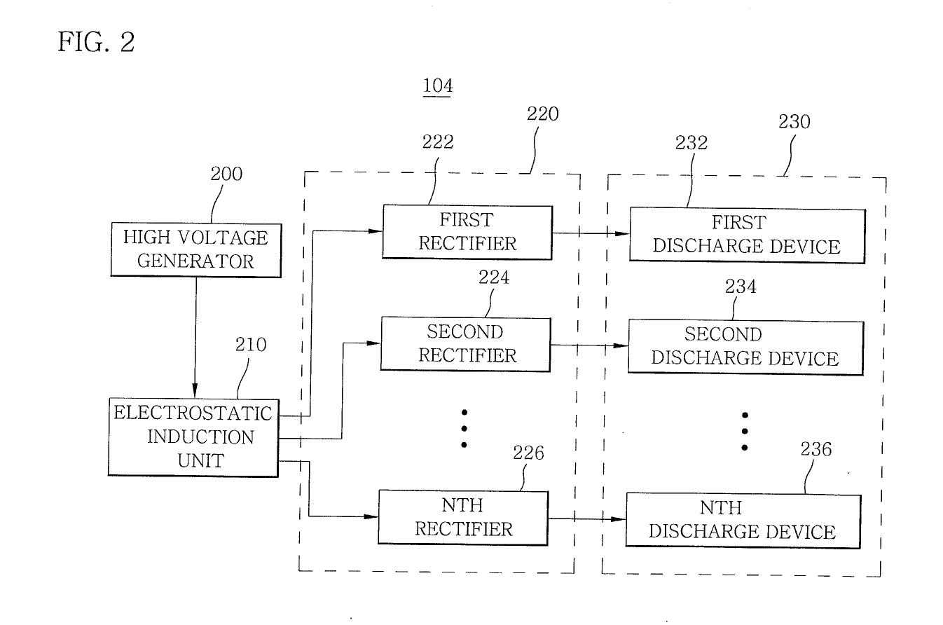

FIG. 2 shows a schematic block diagram of the plasma gas generation apparatus in accordance with the present invention.

As shown in FIG. 2, a high voltage generator 200 boosts an input voltage. The high voltage generator 200 is constructed like a transformer, for boosting the input voltage to a desired level. Generally, the high voltage generator 200 boosts the input voltage to 7,000 to 30,000 volts.

A predetermined level of high voltage from the high voltage generator 200 is provided to an electrostatic induction unit 210 which distributedly supplies the high voltage to a plurality of rectifiers 222, 224 and 226 contained at a rectifying block 220. Each of the rectifiers 222, 224 and 226 converts an alternating current to a direct current, and if necessary, changes a polarity of the current thereby to allow a kind or a polarity of a plasma gas to be altered. Each of the rectified current is provided to each of discharge devices 232, 234 and 236 contained at a discharge block 230. At each of the discharge devices 232, 234 and 236, a discharge phenomenon occurs to generate the plasma gas. A detailed construction of the high voltage generator 200, the electrostatic induction unit 210 and the rectifying block 220 are described in the aforementioned International Patent Laid-open Publication No. WO99/39808, which is incorporated herein by reference.

Hereinafter, the discharge block 230, which effectively produce a large amount of plasma gas, is detailed described.

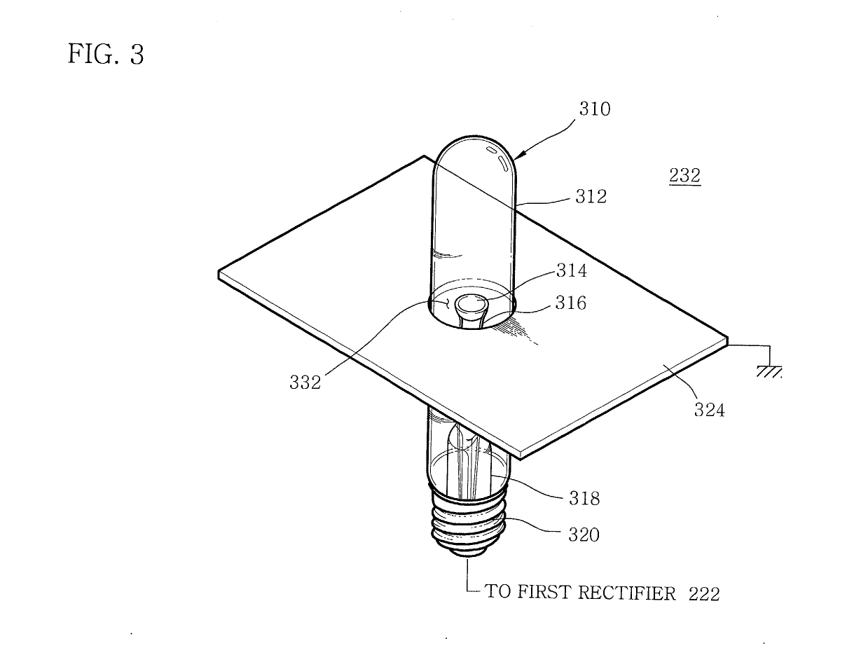

FIG. 3 describes a perspective view of a basic type of discharge device used in the plasma gas generation apparatus in accordance with the present invention.

As shown in FIG. 3, the discharge device 232 includes an electrical bulb 310 having a dish-shaped electrode 314 and a plate electrode 324 located on the same plane with the dish-shaped electrode 314. In case that a high voltage is applied between the electrodes 314 and 324, there occurs a discharge phenomenon.

The dish-shaped electrode 314 is connected to a conductive member 316. The conductive member 316 is supported by a supporting member 318, by which the conductive member 316 and the dish-shaped electrode 314 are prevented from shaking. Externally threaded fixing member 320 is provided to a lower end of the electrical bulb 310 to allow the electrical bulb 310 to be fastened to a socket (not shown).

A partition member 312 which partitions the inside and the outside of the electrical bulb 310 from each other, has a cylindrical configuration which has a rounded distal end. The partition member 312 is made of glass, ceramic, etc., having an impact-resistant characteristic, so that an increased durability is secured. In this regard, it is preferred that transparent material is used to make the partition member 312. Also, it is preferred that vacuum is introduced into the partition member 312 or the partition member 312 is filled with inactive gas such as nitrogen, helium, neon or the like so as to prevent the dish-shaped electrode from oxidizing and vaporizing.

On the other hand, the plate electrode 324 has a hole 332 in which the electrical bulb 310 is inserted. The plate electrode 324 is located on the same position with the dish-shaped electrode 314. The plate electrode 324 is grounded and supported by a supporting member (not shown).

When the high voltage is applied between the dish-shaped electrode 314 and the plate electrode 324 in the discharge device 232, there occurs a discharge phenomenon therebetween, thereby generating the high plasma gas.

Since the discharge occurs in a radial direction between the dish-shaped electrode 314 and a circumferential inner surface of the plate electrode 324, which defines the hole 332, the dish-shaped electrode 314 is formed to have a dish-shaped configuration in view of the fact that an optimal condition for enabling discharge to occur is satisfied when the electrode 314 having the dish-shaped configuration is oppositely arranged to the circumferential inner surface of the plate electrode 324. As described above, between the dish-shaped electrode 314 and the plate electrode 324, there are applied several thousands or several tens of thousands of voltage.

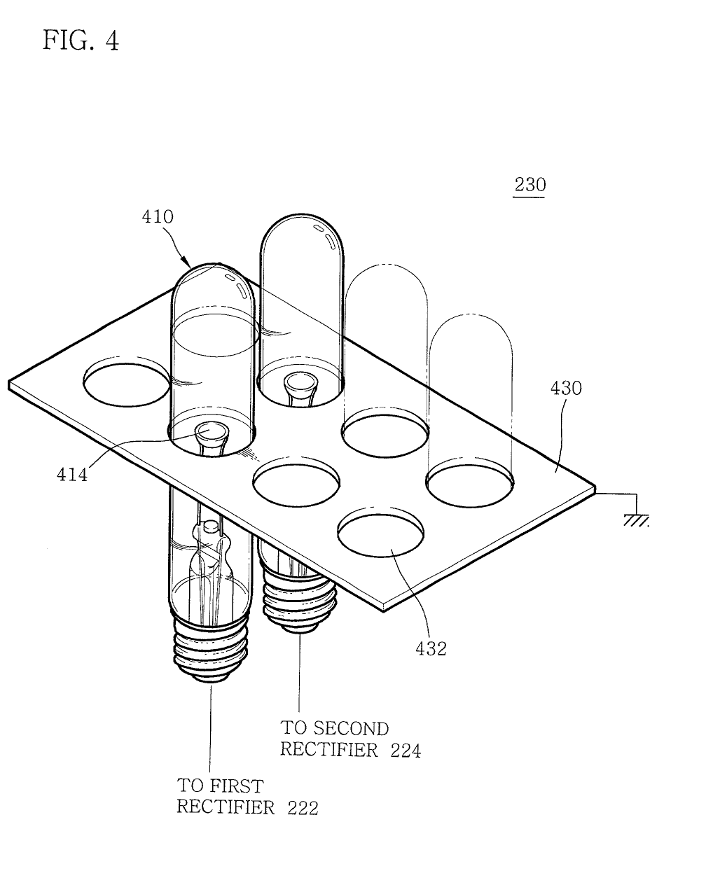

FIG. 4 illustrates a perspective view of a number of discharge devices used in the plasma gas generation apparatus in accordance with one embodiment of the present invention.

As shown in FIG. 4, at least one electrical bulb 410 is inserted through a plate electrode 430.

Since, generally, a great amount of contaminants must be continuously removed in order to purify wastewater, a large amount of plasma gas need to be continuously produced and supplied. Accordingly, in a plasma gas generation apparatus in accordance with the present invention, it is preferred that a plurality of electrical bulbs 410 are provided in such manner that plasma gas is generated between the electrical bulbs 410 and the plate electrode 430, thereby generating the plasma gas.

As shown in FIG. 4, a plurality of holes 432 each of which is capable of accommodating through the electrical bulb 410, are defined in a plate which is serving as the plate electrode 430. The electrical bulbs 410 are inserted through the plurality of holes 432, respectively, in a manner such that the dish-shaped electrode 414 and the plate electrode 430 are maintained at the same height. In a state wherein the electrical bulbs 310 are inserted through the plurality of holes 432, respectively, by applying high voltage to the dish-shaped electrode 414, discharge occurs between the dish-shaped electrode 414 and the plate electrode 430, thereby occurs generating the plasma gas. At this time, in the preferred embodiment of the present invention, the plurality of the electrical bulbs 310 are inserted through the plurality of holes 432, respectively, in a manner such that the bulb 410 and the plate electrode 430 are separated from each other by a predetermined distance which can be several millimeters.

As stated above, in order to effectively produce a large amount of plasma gas thereby to continuously remove a great amount of contaminants, according to the present invention, at least one dish-shaped electrodes are arranged inside each of the electrical bulbs, and at least one plate electrode is located at the same height with at least one dish-shaped electrodes, respectively.

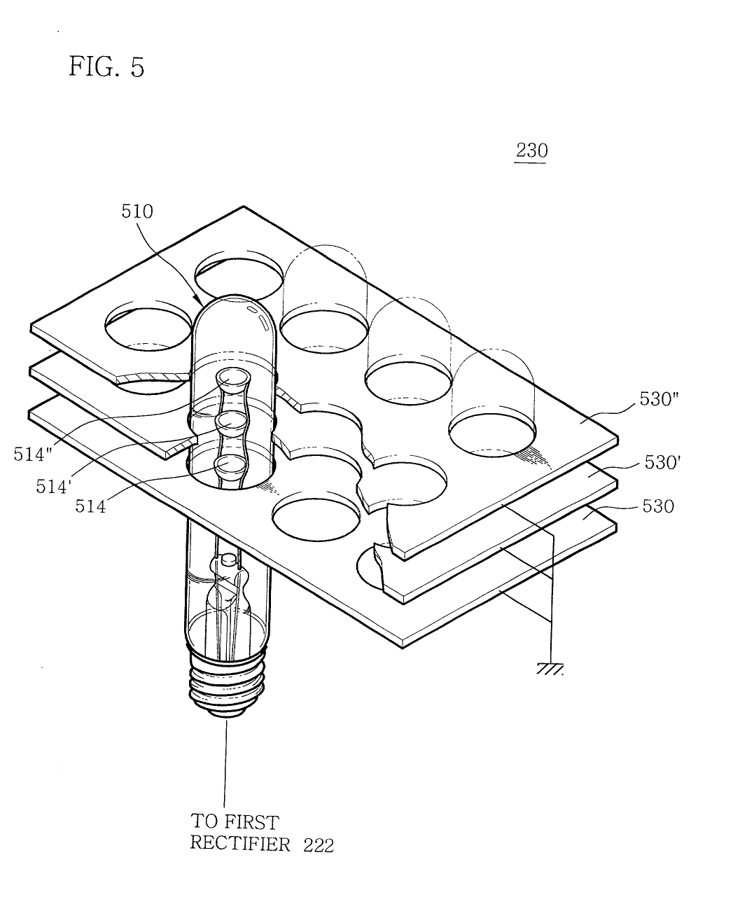

FIG. 5 is a systematic view illustrating a set of discharge devices each of which has three number of dish-shaped electrodes 514, 514′ and 514″ and plate electrodes 530, 530′ and 530″ in accordance with another embodiment of the present invention.

In the discharge devices in accordance with this embodiment of the present invention, discharge occurs between the three dish-shaped electrodes 514, 514′ and 514″ and the plate electrodes 530, 530′ and 530″, respectively, As described above, in the discharge devices according to this embodiment, eight electrical bulbs 510 are used. In association with this, because each of the electrical bulbs 510 has three dish-shaped electrodes 514, 514′ and 514″, discharge simultaneously occurs as a whole at 24 places (3×8) thereby to produce a large amount of plasma gas. Consequently, in the apparatus according to this embodiment, it is possible to produce the plasma gas the amount of which is substantially 24 times that in the case of the basic discharge device having only one dish-shaped electrode and only one plate electrode.

Here, the above embodiment wherein three plate electrodes are located and each of the plate electrodes is formed with eight holes for accommodating eight electrical bulbs therethrough, respectively, was given by way of example. Thereby, persons skilled in the art will appreciate that a plurality of holes can be formed in each plate to accommodate the bulbs which have the number corresponding to that of the holes, a plurality of, (for example, two to five), dish-shaped electrodes can be arranged in each electrical bulb, and a plurality of, (for example, two to five), plate electrodes can be located outside the electrical bulbs in such a manner that they have the number which corresponds to that of the dish-shaped electrodes.

According to the present invention, when high voltage is applied to the electrical bulbs and the plate electrodes, discharge occurs between the dish-shaped electrodes which are arranged inside electrical bulbs and the plate electrodes, respectively. Accordingly, as the discharge occurs continuously, surrounding substances (including air, water, etc.) are ionized under the influence of a high voltage discharge phenomenon, whereby plasma gas is generated.

The plasma gas reacts with contaminants contained in the water or air, thereby rapidly and intensively decomposing them. therefore, the contaminants are rapidly removed from the water or air.

As can be readily seen from the above descriptions, the discharge device in accordance with the present invention enables, with a relatively simple construction, plasma gas to be generated between the electrical bulb and a plate electrode. Since, also, discharge occurs not by a filament having a small diameter, but by a dish-shaped large-sized electrode, suspension of power supply is not caused even with discharge for a lengthy period of time, and high discharge efficiency can be continuously maintained over a long period of time.

Furthermore, since the plate electrode has a number of holes, discharge simultaneously occurs in places, whereby, it is possible to obtain a large amount of plasma gas. Moreover, in the case that a plurality of dish-shaped electrodes and a plurality of plate electrodes are provided, advantages are rendered in that a sufficient amount of plasma gas which are needed for removing contaminants can be inexpensively produced.

Hence, the discharge device and the plasma gas generation apparatus in accordance with the present invention, can be used to purify wastewater, polluted air, drinking water, industrial water or agricultural water. Specifically, because the plasma gas generated by using the plasma gas generation apparatus in accordance with the present invention, perform a function of intensively decomposing contaminants, it is possible to effectively decompose dye which is contained in wastewater discharged from a dyeing factory.

In the drawings and specification, there have been disclosed typical preferred embodiments of the invention and, although specific terms are employed, they are used in a generic and descriptive sense only and not for purposed of limitation, the scope of the invention being set forth in the following claims.

What is claimed is:

1. A discharge device for generating discharge between electrodes by applying a predetermined high voltage therebetween, comprising:
at least one bulb containing at least one dish-shaped electrode therein; and
at least one plate electrode having at least one hole through which the bulb is inserted in a coplanar relationship with respect to the dish-shaped electrode.

2. The discharge device as recited in claim 1, wherein the number of each of the dish-shaped electrode and the plate electrode is equal to 1 through 5.

3. An apparatus for producing plasma gas through the use of discharge phenomenon, comprising;
means for generating a predetermined electric voltage high enough to cause discharge phenomenon;
a discharge device for generating the discharge phenomenon, the discharge device having at least one bulb containing at least one dish-shaped electrode therein, and at least one plate electrode having at least one hole through which the bulb is inserted in a coplanar relationship with respect to the dish-shaped electrode; and
means for distributing the voltage to each of the bulbs of the discharge device.

4. The apparatus as recited in claim 3, wherein the number of each of the dish-shaped electrode and the plate electrode is equal to 1 through 5.

5. A bulb for use in a discharge device for generating discharge between electrodes by applying a predetermined high voltage therebetween, comprising:
means for defining an airtightly maintained inner space;
conductive means for transmitting electric voltage supplied from the outside; and
at least one dish-shaped electrode enclosed by the inner space defining means and connected to the conductive means for enabling discharge phenomenon to occur between the dish-shaped electrode and an outside electrode which is located outside the bulb.
